(19) United States
(12) Patent Application Publication
(10) Pub. No.: US 2006/0209361 A1
(43) Pub. Date: Sep. 21, 2006

(54) Apparatus for reading images and device for adjusting mirror thereof

(75) Inventor: Tetsuya Sato, Shizuoka-Ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/083,278

(22) Filed: Mar. 18, 2005

(51) Int. Cl. H04N 1/04

(52) U.S. Cl. 358/474; 358/511

(57) ABSTRACT

An apparatus for reading images includes: a first carriage having a lamp for exposing a manuscript and a first reflection mirror for reflecting reflected light from the manuscript; a second carriage including second and third reflection mirrors for returning the reflected light from the first carriage; an image forming optical unit for producing an image of the reflected light from the third reflection mirror on an image sensor, a body casing accommodating at least the first and second carriages, the image forming optical unit, and the image sensor, being covered on top thereof by a manuscript glass, and including a hole covered by a removable member on part of the surface thereof; and a mechanism for adjusting mirror angle for adjusting the angle of the second reflection mirror, wherein the mechanism for adjusting mirror angle is capable of adjusting the angle of the second reflection mirror from the hole.

### BACKGROUND OF THE INVENTION

1. Technical Field of the Invention

The present invention relates to a technique for reading images on a manuscript using an image forming optical system and, more specifically, to an apparatus for reading images and a device for adjusting mirror thereof which can carry out image skew adjustment of reading images easily from the outside of a scanner unit.

2. Related Art

In the related art, an image scanner mounted on a copying machine or a single scanner unit includes a device for adjusting the inclination of an optical unit (first carriage, second carriage) placed therein.

In Japanese Unexamined Patent Publication Kokai No. 06-22096 discloses a device for adjusting inclination of the carriage as an example of the adjusting device. This adjusting device has a function of adjusting the length of one of the drive wires provided on both ends of the first carriage and the second carriage. The adjusting device can be accessed from the outside of the scanner.

However, the adjusting device can apply a load for a driving wire and is only for adjusting the inclination of the carriage. The inclination of a reflection mirror mounted on the carriage could not be adjusted, disadvantageously.

### SUMMARY OF THE INVENTION

An object of the invention is to provide an apparatus for reading images and a device for adjusting mirror thereof which can carry out the scanner mirror adjusting operation efficiently and easily, and improve a working efficiency.

In order to achieve the above-described object, the apparatus for reading images of the invention includes a first carriage having a lamp for exposing a manuscript and a first reflection mirror for returning reflected light from the manuscript, a second carriage including second and third reflection mirrors for reflecting the reflected light from the first carriage; an image forming optical unit for producing an image of the reflected light reflected from the third reflection mirror on an image sensor, a body casing having at least the first carriage, the second carriage, the image forming optical unit, and the image sensor stored therein, being covered on top thereof by a manuscript glass for placing the manuscript thereon, and including a hole covered by a removable member formed on part of the surface thereof; and a mechanism for adjusting mirror angle provided at an end of the second reflection mirror for adjusting the angle of the second reflection mirror, wherein the mechanism for adjusting mirror angle is adapted to be capable of adjusting the angle of the second reflection mirror from the hole.

In order to achieve the object described above, the device for adjusting mirror of the apparatus for reading images according to the invention includes a carriage for holding a mirror, a pair of holders for supporting both ends of the mirror and fixed to the carriage, and the mechanism for adjusting mirror angle provided on at least one of the holders.

### BRIEF DESCRIPTION OF THE DRAWINGS

FIG. 1 is a schematic drawing of an MFP (Multi-Function Peripherals) including an apparatus for reading images according to the invention;

FIG. 2 is a cross-sectional side view of a scanner unit according to a first embodiment of the apparatus for reading images according to the invention;

FIG. 3 is a perspective view of a second carriage provided on the scanner unit as the apparatus for reading images according to the invention;

FIG. 4 is a partial perspective view of the second carriage when viewed from the rear side of the scanner unit;

FIG. 5 is an exploded perspective view showing a mirror holder on the rear side of the second carriage and an adjusting bracket of a mechanism for adjusting mirror angle to be mounted to a mirror holder;

FIG. 6 is a perspective view of a leaf spring provided on the mechanism for adjusting mirror angle;

FIG. 7 is a drawing showing a cross-section of the mechanism for adjusting mirror angle in a schematic manner;

FIGS. 8A and 8B are drawings showing examples of the states of skew of the manuscript images corresponding to printing paper respectively;

FIG. 9 is a schematic drawing showing a control block of the apparatus for reading images; and

FIG. 10 is a flowchart showing adjustment of back-and-force movement of mirror of the second carriage provided on the apparatus for reading images of the invention.

### DETAILED DESCRIPTION OF PREFERRED EMBODIMENTS

Referring to the attached drawings, a preferred embodiment of an apparatus for reading images according to the invention will be described.

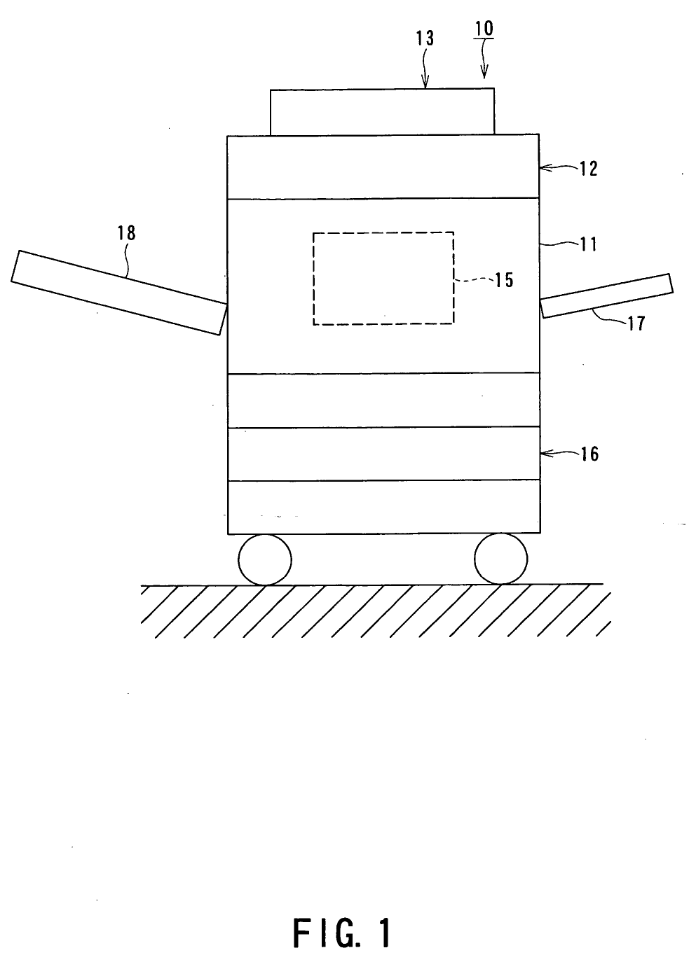

The apparatus for reading images according to the invention is applied to an image reading section of a MFP, a copying machine or an image scanner. FIG. 1 is a schematic drawing of a MFP 10 where the apparatus for reading images of the invention is applied to the MFP 10.

The MFP 10 includes a scanner unit 12 installed on top of a body casing 11 which constitutes an apparatus body. An automatic manuscript feeding unit 13 for feeding the manuscript automatically is provided on the scanner unit 12. The automatic manuscript feeding unit 13 may be an automatic both-side manuscript feeding unit which is capable of feeding on both sides by reversing the manuscript.

The body casing 11 includes a printer section 15 for printing on paper and a paper feed carriage 16 on the lower side of the body casing 11. On the paper feed carriage 16 accommodates a plurality of paper feed cassettes, and the respective paper feed cassettes accommodate a plurality of types of papers so as to be capable of being fed automatically.

A manual paper feed tray 17, which enables manual paper feeding, is provided so as to be capable of opening and closing on one side (right side) of the body casing 11, and a paper discharge tray 18 for accumulating paper printed in the printer section is provided on the other side (left side).

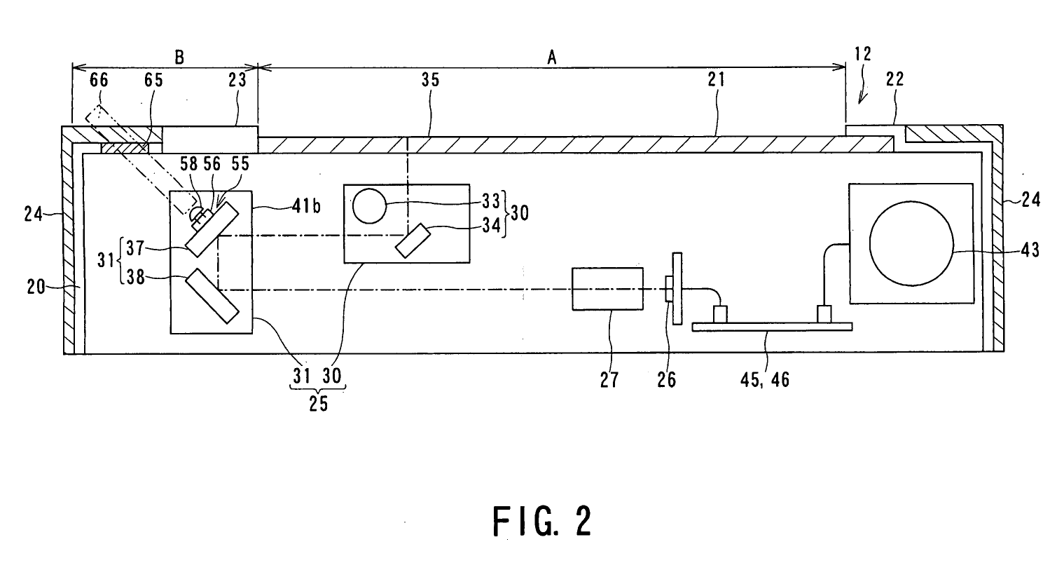

FIG. 2 shows a cross-sectional side view of the scanner unit 12. A square manuscript glass table 21, on which a manuscript can be placed, is provided on top of a unit frame 20. The manuscript glass table 21 is formed of transparent glass material, and it is also possible to form the manuscript glass table of transparent resin material such as acryl resin.

The manuscript glass table 21 is placed on the unit frame 20 and is held by a glass holder 22. A manuscript guide 23 for guiding the manuscript to be placed on the manuscript glass table 21 to a predetermined position is installed on the opposite side of the glass holder 22. The circumference of the unit frame 20 except for the manuscript glass table 21 is covered by a resin top cover 24, and hence the interior of the scanner unit 12 is hermetically closed.

The scanner unit 12 includes a scanning optical system 25 for transmitting reflected light from the manuscript obtained by irradiating the manuscript placed on the manuscript glass table 21 and an image forming optical system 27 for forming the image of the manuscript image transmitted by the scanning optical system 25 on an image sensor 26. The manuscript image formed by the image forming optical system 27 is adapted to be read by the image sensor 26 such as a CCD line sensor or a CMOS sensor.

The scanning optical system 25 includes a first carriage 30 and a second carriage 31 extending from the front side to the rear side of the scanner unit 12. The first and second carriages 30, 31 are capable of reciprocating on a guiding rail, not shown, by a scanner drive motor 43 along the longitudinal direction of the manuscript glass table 21 while keeping a speed ratio of 2:1. The first carriage 30 holds a light source lamp 33 and a first reflection mirror 34. The light source lamp 33 irradiates the manuscript placed on the manuscript glass table 21, and reflected light thereof is, guided by the first reflection mirror 34, which is an elongated square flat mirror, to the second carriage 31.

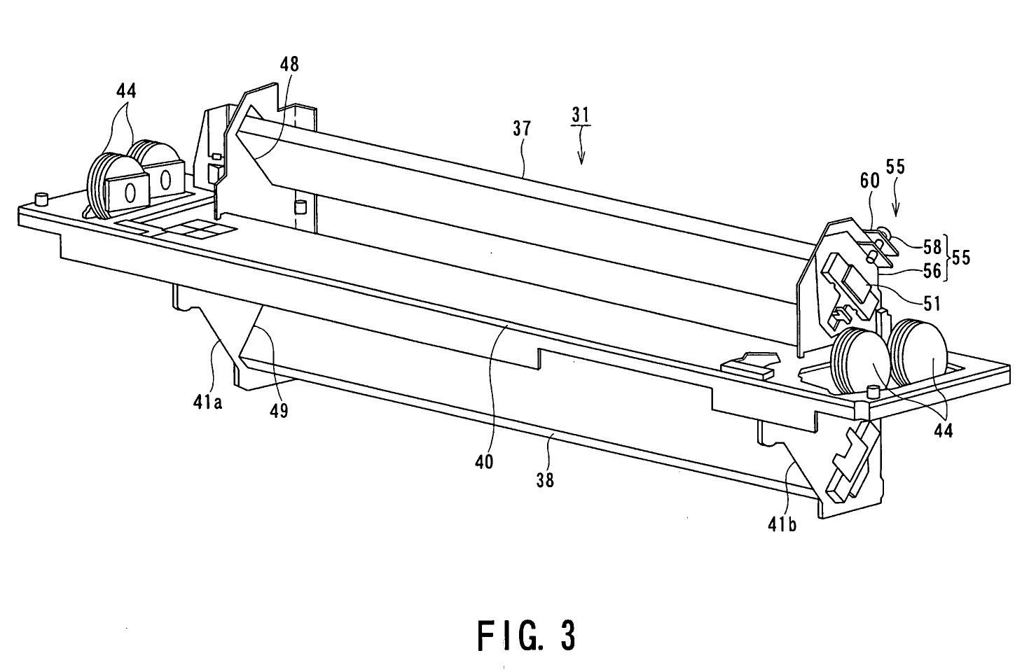

The second carriage 31 includes a second reflection mirror 37 and a third reflection mirror 38 as shown in FIGS. 2 and 3. The second and third reflection mirrors 37, 38 are disposed so that the mirror surfaces thereof are orthogonal to each other at a right angle so as to be capable of returning the reflected light from the first carriage 30 and guiding the same to the image forming optical system 27. The second and third reflection mirrors 37, 38 of the second carriage 31 also compose of the same elongates square flat mirrors as in the first reflection mirror 34, and extend from the front side to the rear side of the scanner unit 12.

The second carriage 31 includes a square carriage frame 40, as shown in FIG. 3 and a plate shaped mirror holders 41a, 41b disposed on the front side and the rear side of the carriage frame 40 so as to oppose to each other in pair. The mirror holders 41a, 41b are fixed to the plate shaped carriage frame 40 with small screws. The second and third reflection mirrors 37, 38 are held by the mirror holders 41a, 41b.

Disposed on the front side and the rear side of the carriage frame 40 is a driven pulley 44 around which a drive wire, not shown, is wound. The skew travel adjustment of the first carriage 30 and the second carriage 31 is achieved by adjusting a tension of the wire by a device for adjusting screw travel, not shown. The operation of the drive motor 43 is controlled by a motor driver substrate 45. The manuscript image captured by the image sensor is also controlled by a scanner driver substrate 46. The motor driver substrate 45 and the scanner driver substrate 46 are provided on a common substrate.

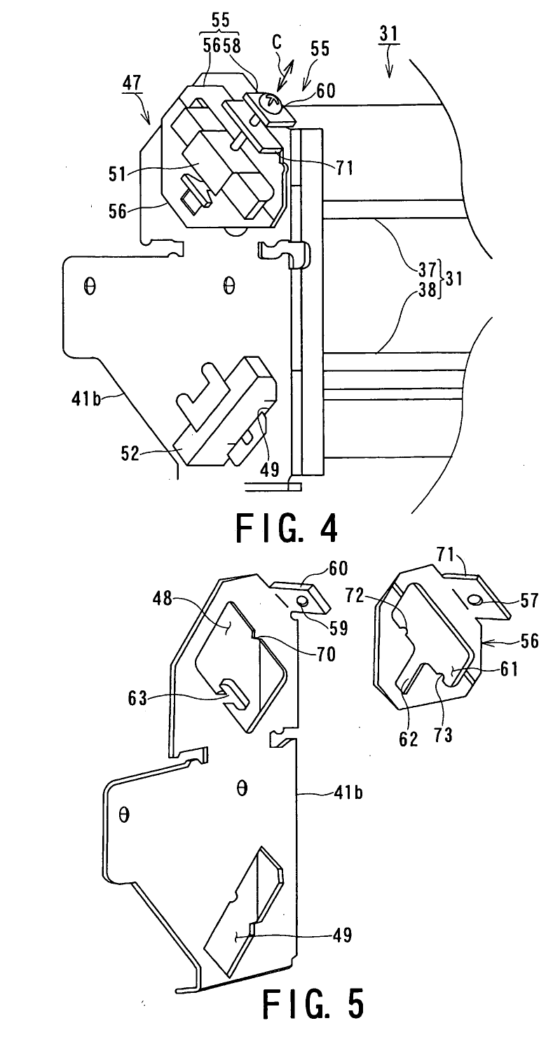

FIGS. 4 and 5 show an adjusting device 47 for the second and third reflection mirrors 37, 38. The second carriage 31 includes the mirror holders 41a, 41b on the front side and the rear side of the carriage frame 40, and the respective mirror holders 41a, 41b resiliently hold the second and third reflection mirrors 37, 38 to mirror holding openings 48, 49 via leaf springs 51, 52, respectively. The leaf springs 51, 52 are mounted to the mirror ends of the second and third reflection mirrors 37, 38 for clamping and reinforcing the mirror ends.

The rear side mirror holder 41b holds one side of the second reflection mirror 37 from the rear side via a mechanism 55 for adjusting mirror angle so that the mirror can move back and force freely in the direction “S”.

The mirror angle adjusting mechanism 55 is provided near the mirror holding opening 48 for the second reflection mirror 37, which is located on the upper side of the rear side mirror holder 41b. The mirror angle adjusting mechanism 55 includes the mirror holder 41b, an adjusting bracket 56, the leaf spring 51, and an adjusting screw 58.

The mirror holder 41b is fixed to the second carriage 31. The mirror holder 41b includes the mirror holding opening 48, a leaf spring fixing projection 70, a slide guide 63, and a supporting bracket 60. The second reflection mirror 38 is inserted into the mirror holding opening 48. The projection 70 is for fixing one end of the leaf spring 51.

The slide guide 63 is disposed on the side of the reflecting surface of the second reflection mirror 37 with respect to the opening 48 for controlling the sliding direction of the adjusting bracket 56. The supporting bracket is disposed on the opposite side of the slide guide 63 with respect to the opening 48, and supports the adjusting screw 58. The supporting bracket 60 is disposed substantially in parallel with the reflecting surface of the second reflection mirror 38 and is formed integrally with the mirror holder 41a by bending part of the mirror holder 41a. Provided at the center of the supporting bracket 60 is a screw guide 59 in which the adjusting screw 58 is inserted. The screw guide 59 is not formed with a screw groove.

The adjusting bracket 56 includes a plate with a shoulder as a base, a mirror holding opening 61, projections 72, 73, a slide groove 62, and a supporting bracket 71. The mirror holding opening 61 has a square shape, and in which the second reflection mirror 37 is inserted. The slide groove 62 extends in a direction perpendicular to the reflecting surface of the second reflection mirror 37, and allows the adjusting bracket 56 in a direction perpendicular to the reflecting surface of the second reflection mirror 37 by being fitted with the slide guide 63. The projections 72, 73 are formed at one side of the opening 61 for supporting the reflecting surface of the second reflection mirror 37 at two points. The supporting bracket 71 extends substantially in parallel with the reflecting surface of the second reflection mirror 37, and is formed integrally with the adjusting bracket 56. The supporting bracket 71 is formed with a screw hole at the center thereof, and a screw guide 57 in which the adjusting screw 58 is inserted.

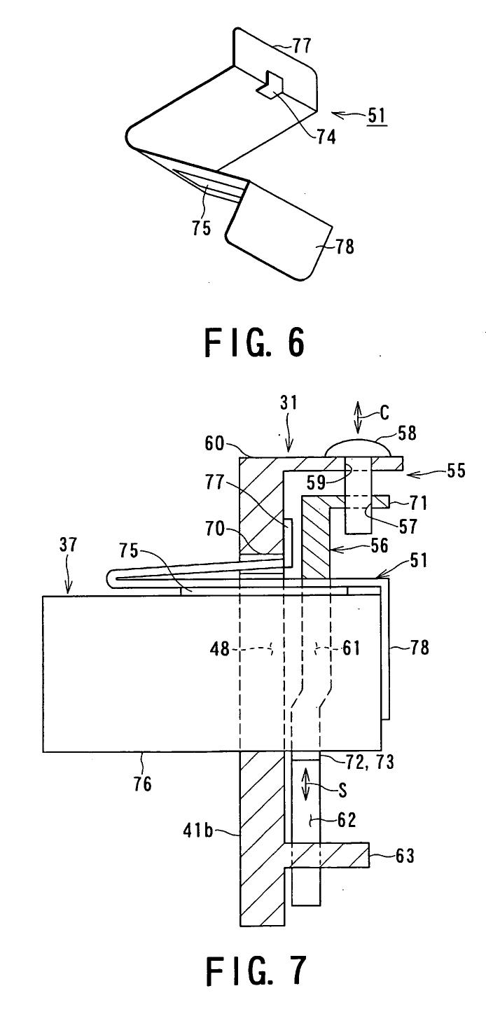

FIG. 6 shows a perspective view of the leaf spring 51. The leaf spring 51 is provided with a notch 74 and a mirror pressing portion 75. The notch 74 is fitted on the projection 70 of the mirror holder 41b. Therefore, one end of the leaf spring 51 is fixed to the mirror holder 41b. The mirror pressing portion 75 presses the center of the back surface of the second reflection mirror 37.

FIG. 7 shows a cross-sectional view of a mirror adjusting mechanism 55. The adjusting bracket 56 is mounted to the outside of the mirror holder 41b fixed to the second carriage 31, and is slidable in the direction S using the slide guide 63 and the slide groove 62. The second reflection mirror 37 is inserted into the mirror holding opening 48 and the mirror holding opening 61. The notch 74 of the leaf spring 51 is fitted on the projection 70 of the mirror holder 41b. The mirror pressing portion 75 of the leaf spring 51 presses the center of the back surface of the second reflection mirror 37, whereby a reflecting surface 76 of the second reflection mirror constantly presses the projections 72, 73 of the adjusting bracket 56. In other words, the adjusting bracket 56 is constantly pressed in the direction C, which is parallel with the direction S by the leaf spring 15. Restraining portions 77, 78 of the leaf spring 51 restrain the longitudinal movement of the second reflection mirror.

On the other hand, the adjusting screw 58 is inserted into the screw guide 59 of the supporting bracket 60 of the mirror holder 41b, and subsequently, inserted into the screw guide 57 provided on the supporting bracket 71 of the adjusting bracket 56. The adjusting screw 58 constantly receives a spring force of the leaf spring 51 in the direction C. Consequently, the head of the adjusting screw 58 is kept in hermetical contact with the supporting bracket 60.

When the operator rotates the adjusting screw 58, the distance between the supporting bracket 60 and the supporting bracket 71 is varied, and the angle of the second reflection mirror 37 can be adjusted.

At the position of adjustment of the second carriage 31, a jig guide hole 65 is provided on an extension of the adjusting screw 58 in the direction of insertion, as shown in FIG. 2.

The mechanism 55 for adjusting mirror angle provided on the rear side mirror holder 41b of the second carriage 31 is provided in such a manner that the adjusting screw 58 is directed rearward and upward on the rear side of the scanner unit 12 with the screw head projected.

The adjusting position of the scanner unit 12 is formed in a non-image reading area B which is out of an image reading area A as shown in FIG. 2, and the scanner unit 12 is set in such a manner that the adjusting screw 58 of the mirror angle adjusting mechanism 55 is directed rearward and upward on the rear side of the scanner unit 12 and the screw head of the adjusting screw 58 opposes to the jig guide hole 65 of the unit frame 20 when the second carriage 31 is moved to the adjusting position for adjustment.

Then, when the second carriage 31 is at the adjusting position and the top cover 24 is removed from the unit frame 20, the jig guide hole 65 is exposed, and an adjusting driver 66 as an operation jig is inserted through the guide hole 65 to rotate the adjusting screw 58 of the mirror angle adjusting mechanism 55.

The rotation of the adjusting screw 58 of the mirror angle adjusting mechanism 55 can be carried out simply and easily from the outside of the scanner unit 12 only by removing part of the top cover 24 without removing the manuscript glass table 21, and the angle of the second reflection mirror 37 can be adjusted by the rotation of the adjusting screw 58.

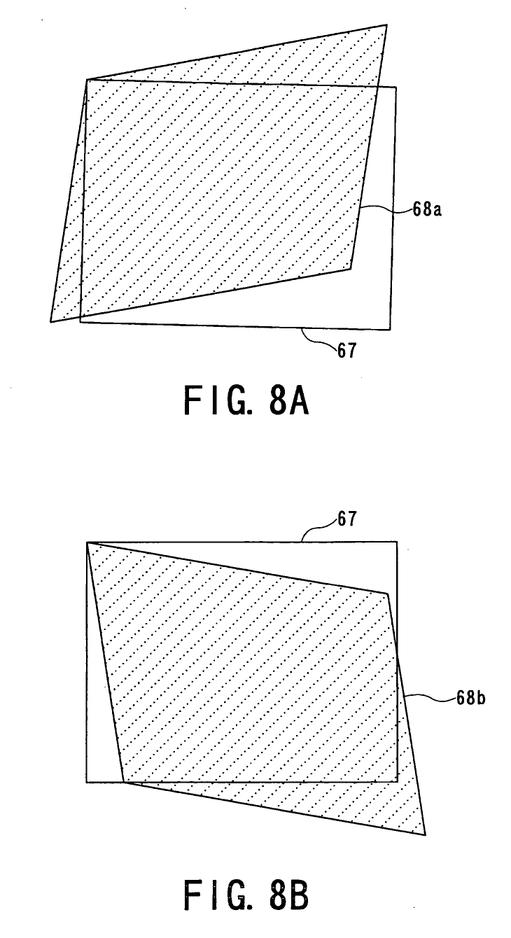

By carrying out adjustment of the angle of the second reflection mirror 37 on the rear side with respect to the third reflection mirror 38 by operating the adjusting screw 58 on the mirror angle adjusting mechanism 55, skew of the manuscript image can be adjusted adequately so as to match the paper as the printing medium, whereby such phenomena that manuscript images 68a, 68b skew in the primary scanning direction and the secondary scanning direction with respect to a paper 67 as shown in FIGS. 8A and 8B may be solved.

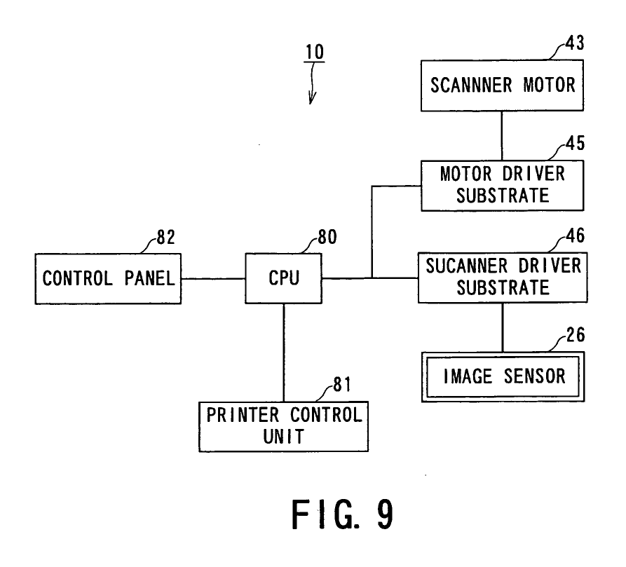

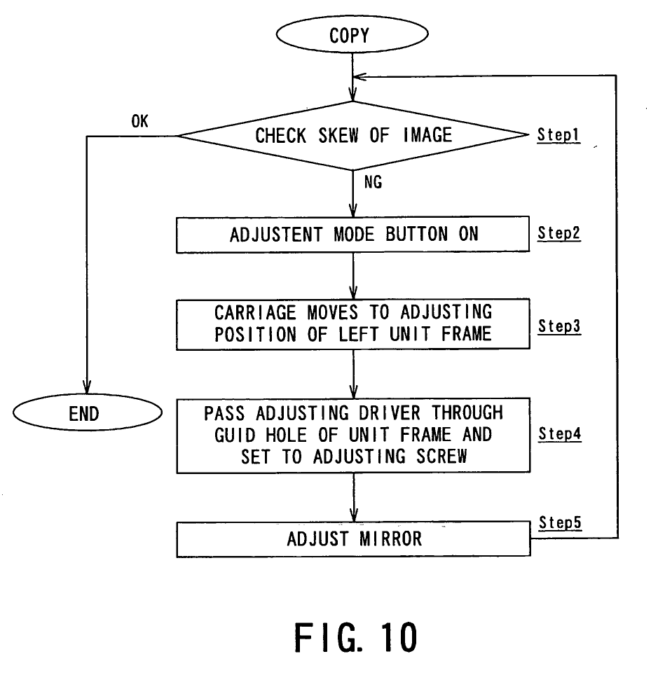

A schematic control block diagram of the MFP 10 which is applied to the apparatus for reading images is shown in FIG. 9. A CPU 80 which controls the entire MFP 10 is connected to a printer control unit 81, the motor driver substrate 45, the scanner driver substrate 46, and a control panel 82. The motor driver substrate 45 controls the rotation of the scanner motor 43. The scanner driver substrate 46 is connected to the image sensor 26, and the image read by the image sensor 26 is transmitted to the CPU 80.

Subsequently, the operation of the apparatus for reading images will be described.

When the MFP 10, the copying machine, or the image scanner are operated, the scanner unit 12, which constitutes the apparatus for reading images, is also activated.

The printer control unit 81 controls the printer section 15. A control panel 19 transmits instructions from the user to the CPU 80. The CPU 80 controls the MFP 10 based on the instructions.

When the scanner unit 12 is activated, a manuscript 35 is set on the manuscript glass table 21 automatically by the automatic manuscript feeding unit 13 or by manual operation as shown in FIG. 2.

Subsequently, light from the light source lamp 33 of the first carriage 30 is illuminated onto the manuscript 35 placed on the manuscript glass table 21, and the reflected light therefrom is received by the first reflection mirror 34, which is reflected again toward the second carriage 31.

The reflected light guided from the first reflection mirror 34 of the first carriage 30 is reflected on the second reflection mirror 37 and the third reflection mirror 38 of the second carriage 31 in sequence and returned, and then, is guided by the image forming lens of the image forming optical system 27 to form an image on the image sensor 26 such as the CCD sensor, where the manuscript image is read.

The first carriage 30 and the second carriage 31 move at a speed ratio of 2:1 in the secondary scanning direction. Generally, the secondary scanning direction is defined as the direction of movement of the second carriage, and the primary scanning direction is defined as the longitudinal direction of the mirror. The manuscript image formed on the image sensor 26 is sent to the printer section 15 after having stored once in a memory, not shown, or directly under the control of the scanner driver substrate 46, and is printed on the paper 67 by the printer section 15.

By the operation of the scanner unit 12, which is the apparatus for reading images, a motor drive force of the scanner drive motor 43 is transmitted to the first carriage 30 and the second carriage 31, which reciprocate in the direction along the optical axis of the image forming optical system 27 while keeping a predetermined speed ratio. With this reciprocating movement, the first carriage 30 moves in the primary scanning direction (line direction) over the entire surface of the manuscript placed on the manuscript glass table 21, and the second carriage 31 follows the movement of the first carriage 30.

When distortion such as the manuscript images 68a, 68b as shown in FIGS. 8A and 8B in the direction of the primary scanning direction (line direction) and the secondary scanning direction (row direction) of the manuscript image read by the image sensor 26 of the scanner unit 12, adjustment of the scanner mirror is carried out by the mirror angle adjusting mechanism 55.

Referring now to FIG. 7, how to adjust the scanner unit 12 will be described.

The operator outputs the image read by the scanner section of the scanner unit 12 by the printer section 15. When the operator found that there was skew of the image on the output result (Step 1), the operator operates the control panel 82 to activate an adjustment mode (Step 2).

When the adjustment mode is activated, the scanner motor 43 rotates to move the first and second carriages 30, 31 from the carriage waiting position to the mirror adjusting position, and then stops (Step 3).

Subsequently, the operator removes a member which covers the jig guide hole 65. The operator inserts the driver 66 for adjustment into the jig guide hole 65 (Step 4), and rotates the adjusting screw 58 to fine adjust the angle of the second reflection mirror 37(Step 5). After having completed the adjustment, the operator outputs the image again by the printer section 15 and determines whether or not the result of adjustment is correct. When the result of adjustment is determined to be correct, the operator mounts the cover member which covers the jig guide hole 65 and inputs “adjustment completed” to the control panel 82. When the result of adjustment is not sufficient, the operator tries adjustment again.

What is claimed is:

1. An apparatus for reading images comprising:
a first carriage having a lamp for exposing a manuscript and a first reflection mirror for reflecting reflected light from the manuscript;
a second carriage including second and third reflection mirrors for returning the reflected light from the first carriage;
an image forming optical unit for producing an image of the reflected light reflected from the third reflection mirror on an image sensor;
a body casing having at least the first carriage, the second carriage, the image forming optical unit, and the image sensor stored therein, being covered on top thereof by a manuscript glass for placing the manuscript thereon, and comprising a hole covered by a removable member formed on part of the surface thereof; and
a mechanism for adjusting mirror angle provided at an end of the second reflection mirror for adjusting the angle of the second reflection mirror,
wherein the mechanism for adjusting mirror angle is adapted to be capable of adjusting the angle of the second reflection mirror from the hole.

2. The apparatus for reading images according to claim 1, wherein the second carriage comprises a pair of holders which support both ends of the second reflection mirror and are fixed to the second carriage, and
the mechanism for adjusting mirror angle is provided on one side of the holders.

3. The apparatus for reading images according to claim 2, the mechanism for adjusting mirror angle is mounted to one end of the second reflection mirror and comprises:
a slide member being slidable in the direction perpendicular to the mirror surface of the second reflection mirror with respect to the holder; and
an adjusting screw for adjusting the sliding amount of the slide member with respect to the holder.

4. The apparatus for reading images according to claim 3, wherein the second reflection mirror is inserted into holes which are formed on the holder and the slide member respectively.

5. The apparatus for reading images according to claim 4, wherein the second reflection mirror is pressed against the slide member by a resilient body.

6. The apparatus for reading images according to claim 5, wherein one end of the resilient body is fixed to the holder.

7. The apparatus for reading images according to claim 5, wherein the holder comprises a guide member for guiding the sliding direction of the slide member.

8. The apparatus for reading images according to claim 3, wherein a hole is formed on the body casing on an extension of the adjusting screw in the tightening direction.

9. The apparatus for reading images according to claim 1, further comprising a control panel for inputting instruction for moving the second carriage to a position for adjustment.

10. The apparatus for reading images according to claim 9, wherein the first and second carriages move in the secondary scanning direction at a speed ratio of 2:1.

11. A device for adjusting mirror for an apparatus for reading images comprising:
a carriage for holding a mirror;
a pair of holders which support both ends of the mirror and are fixed to the carriage; and
a mechanism for adjusting mirror angle provided on at least one of the holders.

12. The device for adjusting mirror of an apparatus for reading images according to claim 11, wherein the mechanism for adjusting mirror angle comprises:
a slide member mounted to one end of a second reflection mirror and is slidable in the direction perpendicular to the mirror surface of the second reflection mirror with respect to the holder; and
an adjusting screw for adjusting the sliding amount of the slide member with respect to the holder.

13. The device for adjusting mirror of an apparatus for reading images according to claim 12, wherein the second reflection mirror is inserted into holes formed on the holder and the slide member, respectively.

14. The device for adjusting mirror of an apparatus for reading images according to claim 13, wherein the second reflection mirror is pressed against the slide member by a resilient body.

15. The device for adjusting mirror of an apparatus for reading images according to claim 14, wherein one end of the resilient body is fixed to the holder.

16. The device for adjusting mirror of an apparatus for reading images according to claim 15, wherein the holder comprises a guide member for guiding the sliding direction of the slide member.
